(19) United States
(12) Patent Application Publication
(10) Pub. No.: US 2025/0200333 A1
(43) Pub. Date: Jun. 19, 2025

(54) PROBING LARGE LANGUAGE MODEL HIDDEN STATE VALUES FOR DETECTING GROUNDING ERRORS IN GENERATION

(71) Applicant: Microsoft Technology Licensing, LLC, Redmond, WA (US)

(72) Inventors: Christopher Robert KEDZIE, Brooklyn, NY (US); Sky Ch WANG, Arlington, VA (US); Jason Michael EISNER, Baltimore, MD (US)

(21) Appl. No.: 18/539,911

(22) Filed: Dec. 14, 2023

(51) Int. Cl. G06N 3/0455

(52) U.S. Cl. CPC G06N 3/0455

(57) ABSTRACT

A large language model has multiple different layers, each layer generating a set of hidden state values that are passed on to a subsequent layer, during generation. A probe accesses the hidden state values and generates a probe output indicative of how likely a next token to be generated will be an undesirable token (such as a hallucination). An action signal is generated based upon the probe output. The action signal can be used to terminate generation, to generate an alert, or to perform other actions.

### BACKGROUND

Computing systems are currently in wide use. Some computing systems host or otherwise implement generative artificial intelligence (AI) models, such as large language models. A large language model is a language model that uses a large number of parameters (often tens of billions or hundreds of billions of parameters).

Such language models may be prompted to perform a wide variety of different types of operations in generating an output. For instance, a prompt may include an instruction to generate a certain type of output (such as a summary, a description, etc.) as well as a set of tokens that have already been generated (the history of the current generation), along with a source of knowledge information that may provide additional context. As one example, a large language model may be asked to generate a summary of an article, where the article is provided as context information. The instruction may also include a limit on word count to be generated, examples of a desired generation, among other things. The large language model attempts to follow the instructions provided in the prompt and to access the source information in generating a set of output tokens (such as words, phrases, or other linguistic units).

Of course, this is just one type of generative large language model. Other types of large language models can be used to classify inputs into one or more different classes, to provide conversational outputs (such as in a chat system), to answer questions, to write descriptions, or to perform other generative functions.

The discussion above is merely provided for general background information and is not intended to be used as an aid in determining the scope of the claimed subject matter.

### SUMMARY

A large language model has multiple different layers, each layer generating a set of hidden state values that are passed on to a subsequent layer, during generation. A probe accesses the hidden state values and generates a probe output indicative of how likely a next token to be generated will be an undesirable token (such as a hallucination). An action signal is generated based upon the probe output. The action signal can be used to terminate generation, to generate an alert, or to perform other actions.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a large language model architecture.

FIG. 2 is a block diagram showing one example of an encoder, in more detail.

FIG. 3 is a block diagram showing one example of a decoder, in more detail.

FIG. 4 is a block diagram illustrating deployment of a linear probe.

FIG. 5 is a block diagram illustrating deployment of an attention pooling probe.

FIG. 6 is a block diagram showing one example of deployment of an ensemble probe.

FIG. 7 is a flow diagram illustrating one example of the operation of architectures and systems shown in previous figures in using a probe to generate a probe output indicative of how likely a next token to be generated will be an undesirable token, based upon hidden state values in a large language model.

FIG. 8 is a block diagram showing one example of a training system architecture.

FIG. 9 is a flow diagram showing one example of how a probe is trained.

FIG. 10 is a block diagram of one example of a fine tuning training system.

FIG. 11 is a flow diagram illustrating one example of the operation of the training system shown in FIG. 10.

FIG. 12 is a block diagram showing one example of a computing environment that can be used in the systems and architectures shown in previous figures.

### DETAILED DESCRIPTION

As discussed above, large language models are often prompted to generate output tokens based upon information in a prompt (or input). One problem with large language models is that a large language model may, at times, generate an output that is not supported by the input information. An output that is supported by the input information is referred to as a “grounded” output while an output that is not supported by the input is sometimes referred to as an “ungrounded output” or as a “hallucination”. Some examples of hallucinations are outputs that contradict the source of information that was provided as an input to the large language model. Another type of hallucination is an output that draws a conclusion that is not explicitly found in the source of information. In general, a hallucination may include such things as predicate errors, where the predicate in a generation is inconsistent with the source of knowledge; entity errors, where the subject or object of a predicate in the generation is inconsistent; circumstance errors, or errors in the time, duration, or location of an event of the predicate; and co-reference errors, in which the predicate errors, entity errors, or circumstance errors may be intrinsic or extrinsic. An intrinsic error occurs when a generated response directly contradicts the source of knowledge, while an extrinsic error means that the generated response is neither entailed nor contradicted by the source of information. For example, given a paraphrase task prompt “paraphrase the following phrase: apples are crimson”, a generated paraphrase of “apples are red” is a faithful or grounded response. A generated paraphrase of “apples are green” is an intrinsic hallucination, and a generated paraphrase of “tomatoes are red” is an extrinsic hallucination.

Some current systems attempt to identify whether a large language model has generated a hallucination by feeding the output (or generation) into another detection model (sometimes referred to as a secondary model) that is trained on, and applied to, the surface text (or generation) from the large language model. However, these types of secondary models are often just as complex as the underlying large language model that generated the error. These types of secondary models also ignore the information that was computed during the generation process (e.g., they ignore the hidden state values that were computed by the large language model during generation of the hallucination). Thus, running such secondary models can greatly increase the amount of computing system resources (e.g., GPU resources) that are used by the generative AI system and can also significantly increase the latency in performing the generation process.

The present description describes a system in which a probe can be deployed to receive the hidden state values generated by a large language model during generation. Because the internal state values have already been generated by the large language model, those values need not be generated, again, by the probe. Thus, the present description describes a system which greatly reduces the cost of computing hallucinations over systems where a secondary model is trained to recognize hallucinations based on the surface text (or generation) from the original large language model. Instead, a probe in accordance with one example of the present description, receives the hidden state values that have already been generated and generates a probe output indicative of how likely it is that the token currently being generated will be a hallucination. The probe can thus be much less complex, requiring far less computational resources (e.g., GPU cycles, memory, etc.) than other current systems that are used to identify hallucinations which often deploy the secondary large language model to process the output from the original large language model. The speed of generation is also significantly increased as the output of the original large language model can be surfaced without needing to pass it through a secondary large language model.

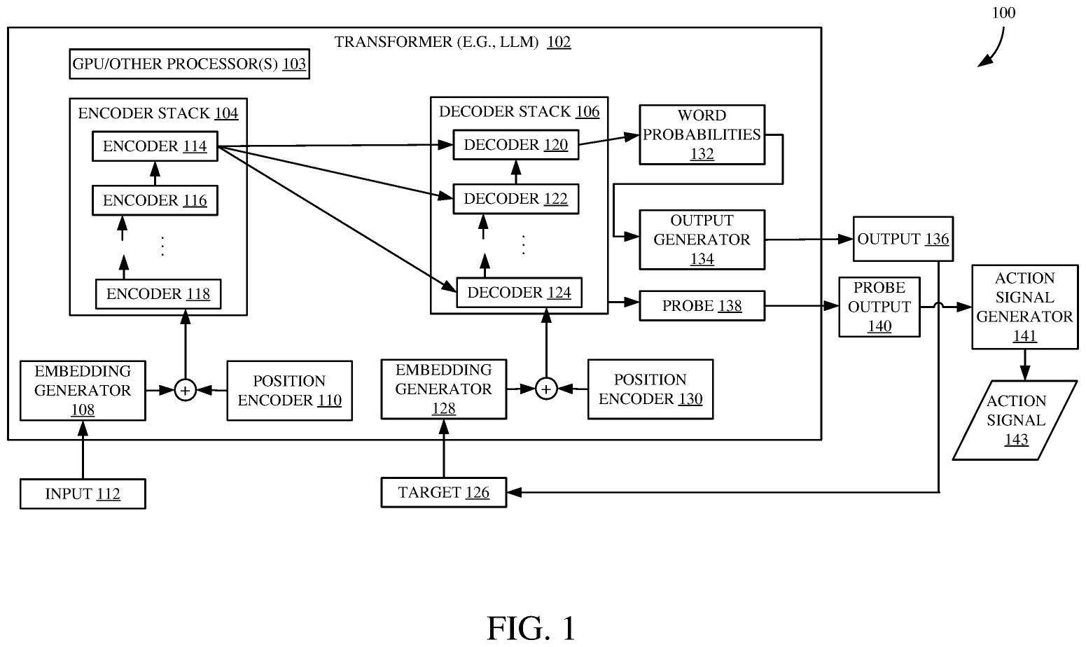

FIG. 1 is a block diagram of one example of a transformer architecture 100 in which transformer 102 (which may be a large language model or LLM) uses a GPU or other processor 103 to run an encoder stack 104 and a decoder stack 106. It will be noted that in other examples the transformer 102 may have a decoder stack only, but the transformer 102 is shown in FIG. 1 as including an encoder stack 104 as well as a decoder stack 106. Transformer 102 also includes embedding generator 108, position encoder 110, embedding generator 128, position encoder 130, output generator 134, and probe 138. Encoder stack 104 includes a plurality of encoders 114, 116, and 118. Decoder stack 106 includes a plurality of decoders 120, 122, and 124.

During inference (once transformer 102 has been trained) only the input sequence 112 is provided and no target sequence 126 is passed into the decoder stack 106. Thus, transformer 102 produces the target sequence 126 from the input sequence 112, alone. The decoder stack 106 generates the target sequence 126 in a loop. The output 136 from a previous time step is fed back into the decoder stack 106 for generation of a next token in a next subsequent time step until the output 136 reaches an end-of-sentence token.

More specifically, during inference the input sequence 112 is converted into embeddings by embedding generator 108 with position information being generated by position encoder 110. The embedding generator 108 encodes the meaning of a word while the position encoder 110 generates position information identifying the position of the word.

Encoder stack 104 processes this information to generate an encoded representation of the input sequence 112 which can be provided to each of the decoders 120, 122, and 124 in decoder stack 106. Instead of receiving a target sequence, during inference, decoder stack 106 uses an empty sequence, at the beginning, with only a start-of-sentence token. The empty sequence is converted into embeddings by embedding generator 128 with position encoder 130 generating position information. The embeddings and position information are fed into decoder stack 106 which processes that input, along with the output from encoder stack 104, to generate an encoded representation of the target sequence. The output layer (decoder 120) may also convert the encoded representation of the target sequence into word probabilities 132 and output generator 134 generates an output sequence 136 based on those word probabilities 132. The last word of the output sequence 136 is identified as the most recently predicted word. That word is now placed in the second position of the target sequence 126 (which now contains a start-of-sentence token and the first word output by output generator 134). This is referred to as the “decoder sequence”. The decoder sequence is fed back into the model (embedding generator 128 and position encoder 130) to generate another output sequence 136 which now has the start-of-sentence token, the first word, and a second word which has just been generated. The second word of the output is now appended to the decoder sequence and the decoder sequence is again fed back into the transformer 102. This is repeated until output generator 134 predicts an end-of-sentence token in output sequence 136.

In training, annotated training data which includes a source or input sequence 112 and a destination or target sequence 126 are provided to transformer 102. Transformer 102 learns how to generate the target sequence 126 from the source or input sequence 112 by using both the input and target sequences 112, 126. A target sequence 126 may illustratively have, at its beginning, a start-of-sentence token which is fed into embedding generator 128. Embedding generator 128 generates an embedding for the start-of-sentence token and position information is generated by position encoder 130. The embedding of the start-of-sentence token is fed, along with the position information, into decoder stack 106. Decoder stack 106 processes the embedded input of target 126, along with the encoded representation of input 112 generated by encoder stack 104 to produce an encoded representation of the target sequence. The output layer (decoder 120) converts the encoded representation of the target sequence into word probabilities 132, and output generator 134 generates a final output sequence 136 based on the word probabilities 132. Training also continues in a loop until an end-of-sentence token is predicted in output sequence 136. A loss function used to train transformer 102 compares the output sequence 136 with the target sequence 126 from the training data. The loss is used to generate gradients to train the transformer 102 during back propagation.

Referring again to the inference operation, some current systems, attempt to identify hallucinations (or undergrounded outputs) using secondary large language models. Thus as the output sequence 136 is generated, the series of tokens in the output sequence 136 is fed into the secondary model that attempts to identify whether the most recent token (or another span of tokens) is a hallucination or undergrounded output. As discussed above, this can be very costly and time consuming.

By contrast, the present system includes probe 138 which accesses the hidden states of one or more of the processing layers in one or more of the various decoders 120, 122, and 124. Probe 138 is trained to generate a probe output 140 indicative of how likely it is that the token currently being generated is a hallucination. The probe output 140 may be a likelihood, a probability, or another metric indicating how likely it is that the token currently being generated is a hallucination. Action signal generator 141 can generate an action signal 143 based upon the probe output 140. The action signal 143 can be used to perform an action such as to control transformer 102 to stop generation, to redirect the transformer 102 in some way, to obtain additional context data, etc.

Also, it will be noted that the present description proceeds with respect to probe 138 identifying a hallucination. However, probe 138 can also be trained to identify other undesirable generations, such as unsafe generations, unlawful generations, salacious generations, or generations that lie outside of other constraints or rules, or generations that present other undesired outcomes.

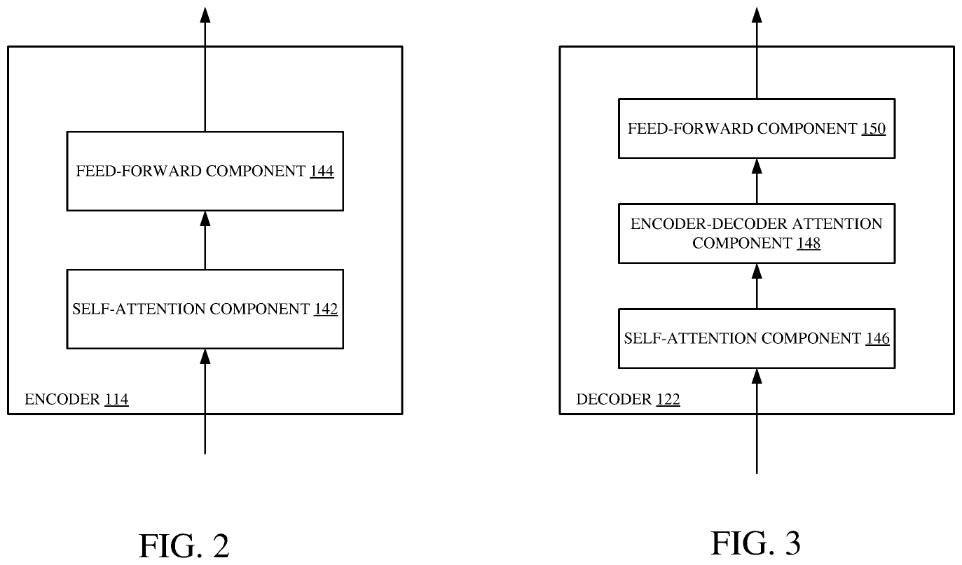

Before proceeding with the present description, a more detailed discussion of an encoder and a decoder will first be provided. FIG. 2 shows a block diagram illustrating one example of encoder 114 in more detail. In one example, all of the encoders 114, 116, and 118 are identical or similar. Encoder 114 has a set of processing layers that includes a self-attention layer (or component) 142 and a feed-forward layer (or component) 144. Self-attention component 142 computes a relationship between different words in the input sequence 112. For instance, self-attention component 142 can, while processing a given word in the given sequence 112, identify other words in the input sequence that are closely related to that word. Thus, self-attention component 142 can generate an output that relates every word in the input sequence 112 to every other word.

The feed-forward component (or layer) 144 receives the output from self-attention component 142 and feeds its output to the next encoder in encoder stack 104. It will be noted that the output from the last encoder 114 in encoder stack 104 feeds its output into each of the decoders in decoder stack 106.

FIG. 3 is a block diagram of one example of a decoder 122. In one example, all of the decoders in decoder stack 106 are identical or similar so that only decoder 122 is described in more detail. Decoder 122 also has a set of processing layers. The input to decoder 122 is fed into self-attention component (or layer) 146. Self-attention component 146 computes a relationship between all of the words that have been generated thus far in the target sequence 126. Encoder-decoder attention component (or layer) 148 works in a similar fashion to self-attention component 146 except that component 148 operates on the output from self-attention component 146 and the output of encoder stack 104. That is, instead of computing a relationship between tokens in the target sequence alone, encoder/decoder attention component 148 computes relationships between the words in the target sequence and the words in the input sequence (as represented in the output from encoder stack 104). The feed-forward component 150 receives an output from encoder-decoder attention component 148 and provides its output to the next decoder in decoder stack 106. The final decoder 120 generates word probabilities 130 that are provided to output generator 134.

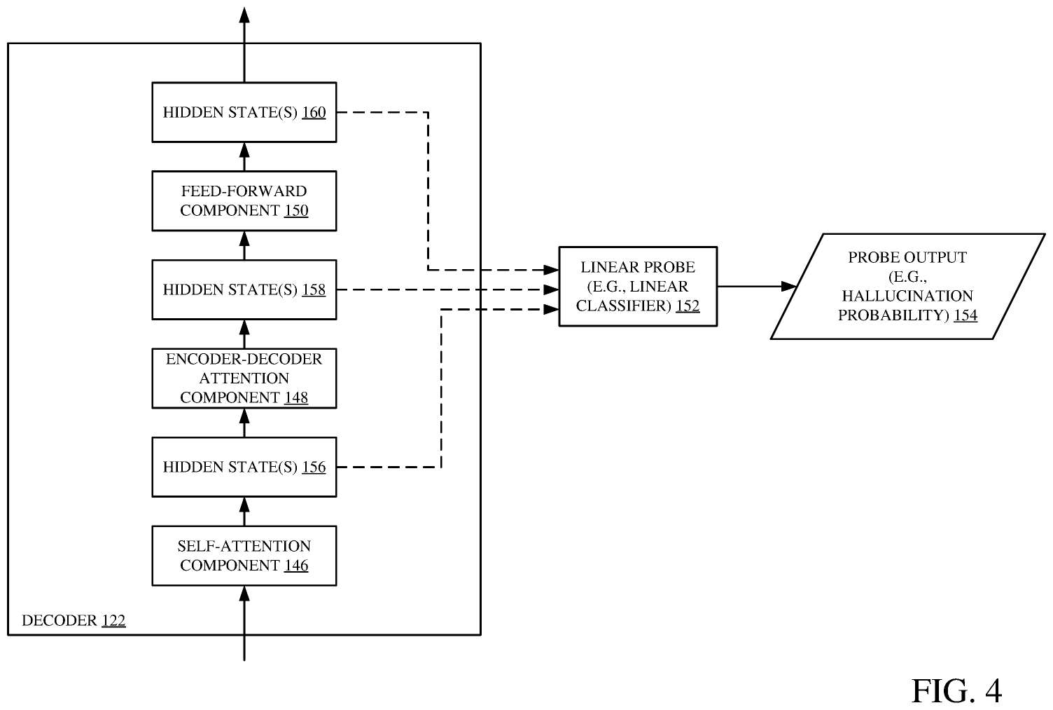

FIG. 4 is a block diagram showing one example of a decoder 122 with a linear probe 152 (one example of probe 138 from FIG. 1) that generates a probe output 154 indicative of a hallucination probability (e.g., the probability that the token that is currently being generated is a hallucination). Some items in decoder 122 are similar to those shown in FIG. 3, and they are similarly numbered. Self-attention component 146 generates an output including hidden states 156, which are provided to encoder-decoder attention component 148. Encoder-decoder attention component 148, in turn, generates an output of hidden states 158 that are provided to feed-forward component 150. Feed-forward component 150 generates an output of hidden states 158 that are provided either to another decoder 106 in the decoder stack or to an output generator 134.

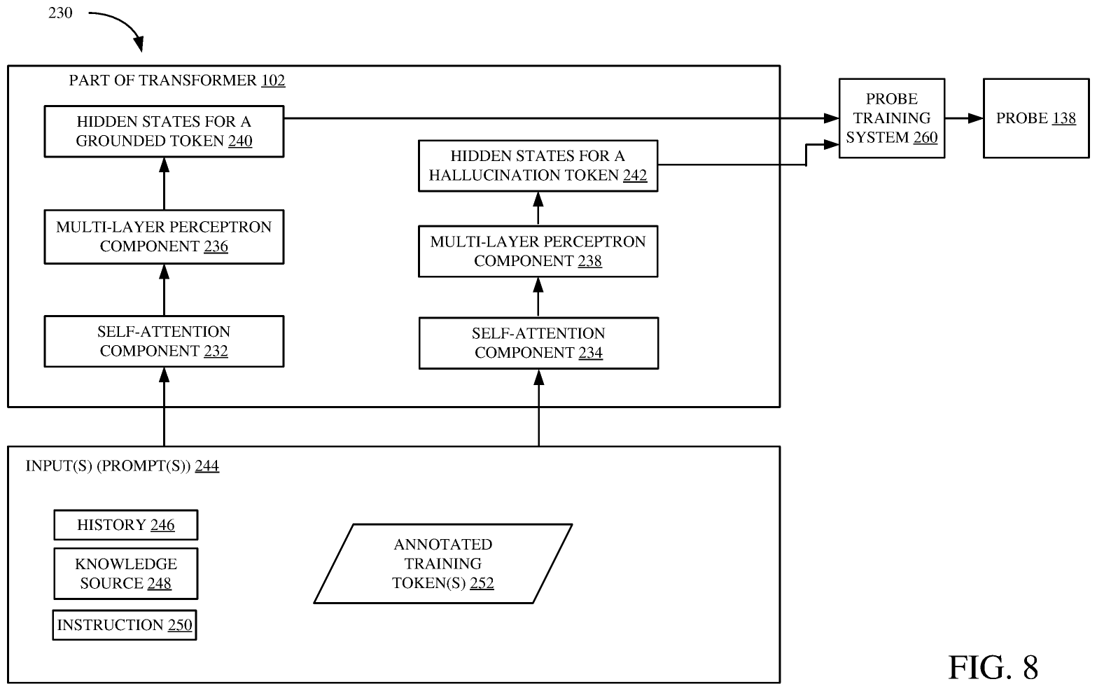

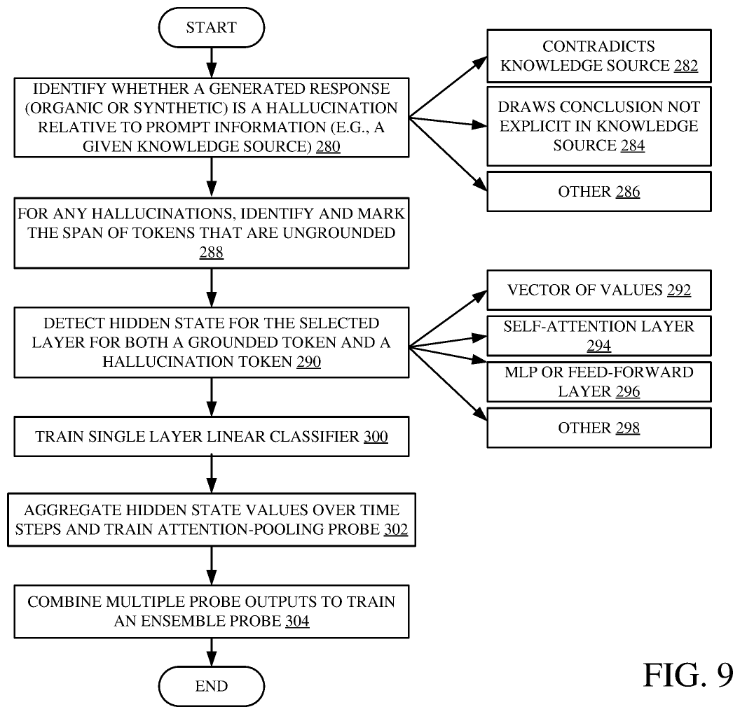

In the example shown in FIG. 4, probe 152 is a linear probe or a linear classifier that receives, as an input, the hidden states that are output from one of the components 146, 148, and 150. Assume, for instance, that linear probe 152 receives the hidden states 160 output from feed-forward component 150. Linear probe 152 is trained to generate probe output 154 to indicate how likely it is that the token currently being generated is a hallucination based upon the values of the hidden states 160. One example of a training architecture that can be used to train linear probe 152 is discussed in greater detail below with respect to FIGS. 8 and 9.

More specifically, linear probe 152 is a linear classifier using a single hidden state (e.g., from one of the components 146, 148, and 150) as an input. Let xᵢ be the i^{th} response token and let hᵢϵ [symbol] ⁿ be the corresponding LLM hidden state at the particular layer and component.

The linear probe probability of hallucination (yᵢ=1) is thus:

$$P ( {y}_{i} = 1 \vert {x}_{i} ) = σ ( {w}^{T} {h}_{i} ) \qquad EQ . 1$$

where

$$ω ∈ {R}^{n} \qquad EQ . 2$$

are learned weights of the probe and σ is the sigmoid function.

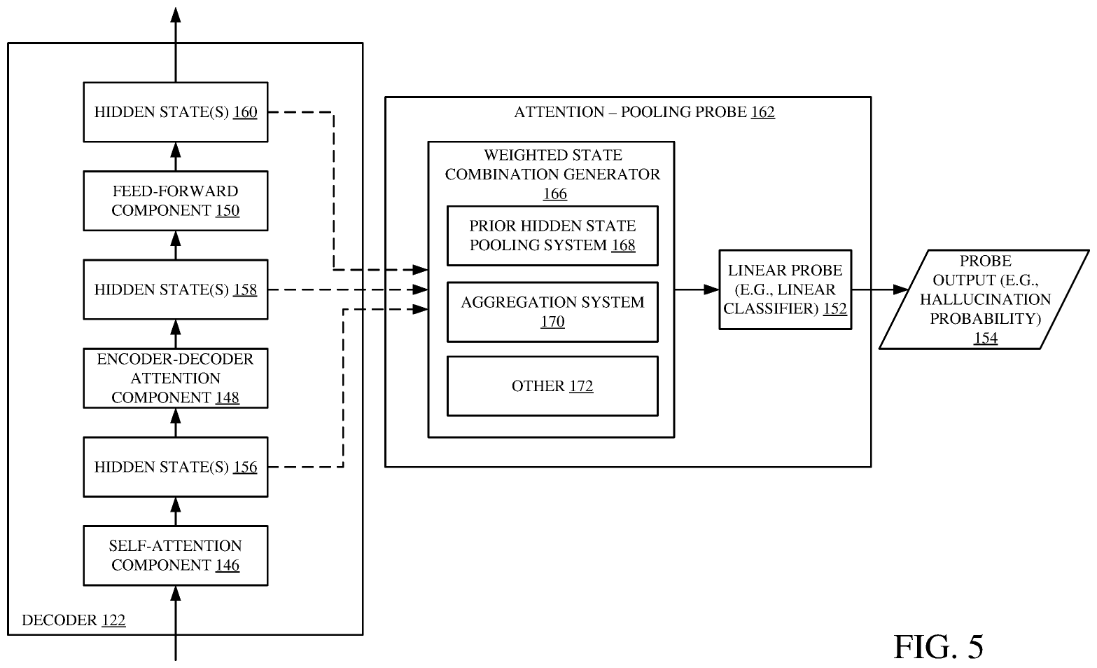

FIG. 5 is a similar to FIG. 4, and similar items are similarly numbered. However, FIG. 5 shows that an attention pooling probe 162 (another example of probe 138 from FIG. 1) is used to generate a probe output 164. Attention pooling probe 162 includes weighted state combination generator 166 which combines hidden state values generated by a layer or component in a decoder in decoder stack 106 over a plurality of different time steps and provides the pooled and aggregated state values to linear probe 152. Linear probe 152 then operates on the pooled state values (instead of a single state as described above with respect to FIG. 4) to generate probe output 164. Thus, weighted state combination generator 166 includes prior hidden state pooling system 168, aggregation system 170, and any other items 172. Prior hidden state pooling system 168 stores or pools the hidden states for all (or a desired number of) previous time steps during the current generation, and aggregation system 170 aggregates those pooled hidden states (such as by computing a weighted average, or another aggregation) and provides the aggregated output to linear probe 152 which, itself, generates probe output 164. Also weighted state combination generator 166 can receive the hidden states from any of the components or layers 146, 148, and 150, in decoder 122 (or in any other decoder in the decoder stack 106).

More specifically, in order to take into account the previous hidden states of the current generation, attention-pooling probe 162 is trained over the previous hidden states from the present generation as follows:

$$p ( {y}_{i} = 1 \vert {x}_{i} ) = σ ( {w}^{T} {\overline{h}}_{i} ) \qquad EQ . 3$$

$$where$$

$${\overline{h}}_{i} = {\sum }_{j = 1}^{i} {a}_{i , j} {h}_{j} \qquad EQ . 4$$

$$and$$

$${α}_{i , j} = \frac{exp ( {q}^{T} {h}_{j} )}{{\sum }_{k = 1}^{i} exp ( {q}^{T} {h}_{k} )} \qquad EQ . 5$$

where qϵRₙ is a learned query vector.

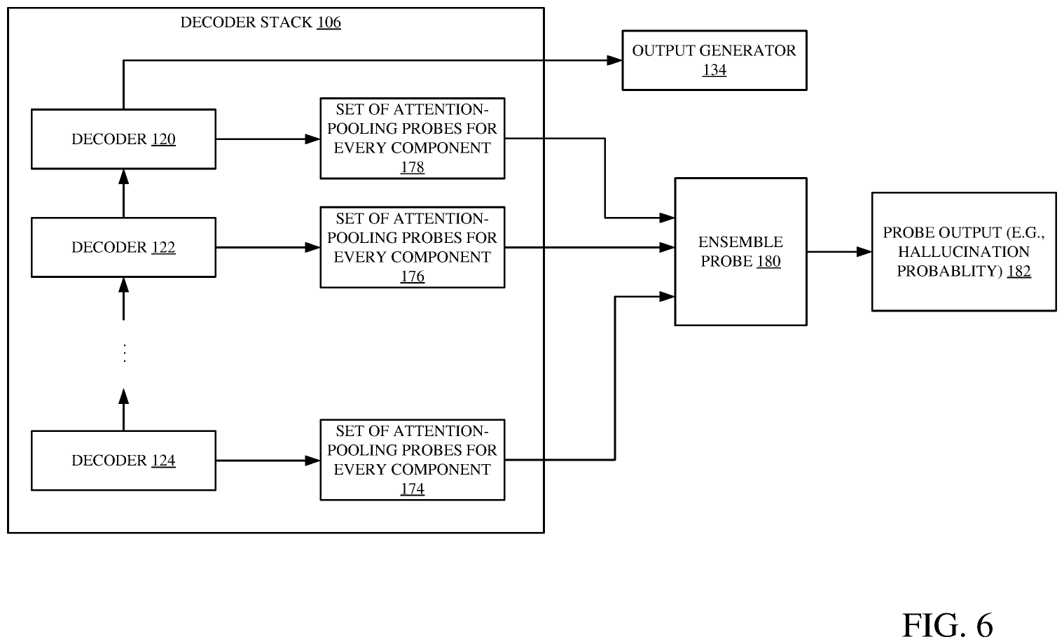

FIG. 6 is a block diagram showing another example of a probe configuration (another example of probe 138 from FIG. 1). In FIG. 6, decoder stack 106 has (as described above with respect to FIG. 1) a plurality of decoders 120, 122, and 124. Decoder 120 generates word probabilities that are provided to output generator 134. Instead of having one or more probes for a single decoder, in the example shown in FIG. 6, a set of attention-pooling probes is trained for every layer, and for every decoder. For instance, a set of attention-pooling probes 174 is trained for each layer in decoder 124. A set of attention-pooling probes 176 is trained for each layer in decoder 122, and a set of attention-pooling probes 178 is trained for each layer in decoder 120. The attention-pooling probes 174, 176, and 178 are similar to attention-pooling probe 162 shown in FIG. 5. The output of each of the sets of attention-pooling probes 174, 176, and 178 is provided to ensemble probe 180. Ensemble probe 180 uses learned mixture weights to combine the individual predictions of each of the attention-pooling probes in the sets of attention-pooling probes 174, 176, and 178, to generate probe output 182.

More specifically, ensemble probe 180 combines predictions across all (L) transformer layers and feed-forward (FF)/self-attention modules or components so that:

$$p ( {y}_{i} = 1 \vert {x}_{i} ) = {\sum }_{{m ∈ \{ FF , Attn . \}}^{l ∈ \{ 1 , … , L \}}} {β}_{l , m} \cdot {p}_{l , m} ( {y}_{i} = 1 \vert {x}_{i} ) \qquad EQ . 6$$

where β_{l,m} are learned mixture weights.

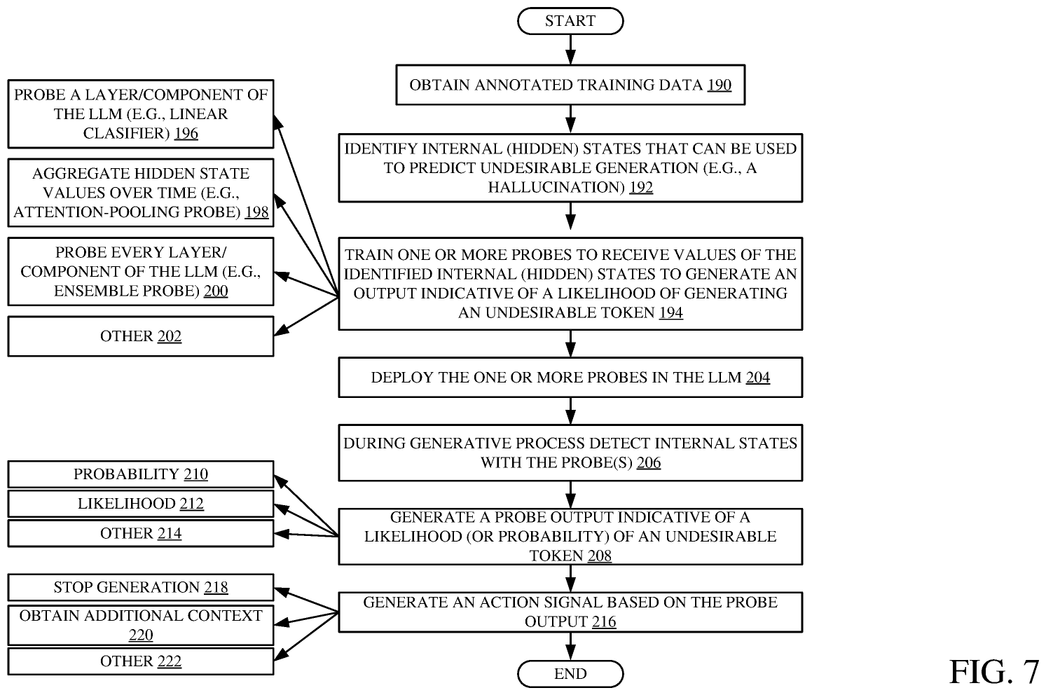

FIG. 7 is a flow diagram illustrating one example of the operation of the architecture 100 illustrated in FIG. 1, in generating a probe output 140 and generating an action signal based upon the probe output 140. A training system architecture (described in greater detail below with respect to FIGS. 8 and 9) identifies which hidden (internal) state should be probed to detect hallucinations. This can be done in a variety of different ways. For example, a probe can be trained using the internal states output by each layer and module and the performance of those probes can be evaluated (such as by comparing the probe performance to manually labeled test sets). The internal states used by the best performing probes will be the internal states probed during generation. In another example, a model can be trained to identify which processing layers or components in which decoders compute internal or hidden states of a transformer that can be used to predict undesirable generation (e.g., a hallucination). Obtaining annotated training data is indicated by block 190 in the flow diagram of FIG. 7 and identifies which particular hidden states in a transformer can be used to predict a hallucination is indicated by block 192 in the flow diagram of FIG. 7.

Then, if the probes are not already trained (as described above), using the identified hidden states, the training system trains one or more probes 138 to receive values of the identified hidden states so that the probe 138 generates an output indicative of how likely it is that the current token being generated will be a hallucination. Training the one or more probes is indicated by block 194 in the flow diagram of FIG. 7. The probes may probe the hidden states of a single layer or component of the large language model (transformer 102), such as described with respect to the linear probe or linear classifier 152 described above with respect to FIG. 4. Training a linear classifier 152 is indicated by block 196 in the flow diagram of FIG. 7. A probe may be trained to aggregate hidden state values over time, such as the attention-pooling probe 162 described above with respect to FIG. 5. Training an attention-pooling probe is indicated by block 198 in the flow diagram of FIG. 7. The probe may be trained to receive hidden states from every layer and/or component of the large language model or transformer 102, such as the ensemble probe 180 described above with respect to FIG. 6. Training an ensemble probe 180 is indicated by block 200 in the flow diagram of FIG. 7.

Other probes can be trained to receive hidden state values and generate an output indicative of how likely it is that the current token being generated is a hallucination (or other undesirable output) as indicated by block 202 in the flow diagram of FIG. 7.

The trained probe or probes are then deployed to the processing layers or components of the large language model for which they were trained. Deploying the probes is indicated by block 204 in the flow diagram of FIG. 7.

During the generative process in the large language model or transformer 102, the deployed probe(s) detect internal or hidden states as indicated by block 206 in the flow diagram of FIG. 7. The probe(s) then generates a probe output indicative of how likely it is that the current generation will spawn an undesirable token, as indicated by block 208. The probe output can be a probability 210 that the token being generated will be a hallucination or another undesirable output. The probe output can be a likelihood 212 that the current generation will be a hallucination or other undesirable token, or the probe output can be any of a wide variety of other indicators 214 indicating whether the current generation is likely to be a hallucination or another undesirable token.

Action signal generator 141 then generates an action signal 143 based upon the probe output 140. Generating an action signal 143 based on the probe output is indicated by block 216 in the flow diagram of FIG. 7. Action signal generator 141 may, for instance, compare the probe output to a threshold value to determine whether to take any action. If the likelihood or probability of a hallucination exceeds the threshold value, then action signal generator 141 may generate an action signal to take some action based upon the probe output 140. The action signal 143 can be an output to transformer 102 to stop the current generation process as indicated by block 218. The action signal can be an output to provide additional context information (such as to extract additional context data from a knowledge store, prompt the user to provide additional context, or obtain additional context in other ways). Obtaining additional context data is indicated by block 220 in the flow diagram of FIG. 7. The action signal 143 can also be to do nothing if the probe output indicates that the likelihood of a hallucination is low enough. The action signal can be any of a wide variety of other action signals as well, as indicated by block 222.

FIG. 8 is a block diagram of one example of a training system architecture 230 in which the probe 138 (e.g., any of the probes 152, 162, and/or 180) are trained. A part of transformer 102 is illustrated in FIG. 5 as having self-attention processing layers or components 232 and 234, multi-layer perceptron (MLP) processing layers or components 236 and 238. While the probes can be trained using the hidden state from any layer or component in transformer 102, FIG. 8 shows that the hidden states from MLP components 236 and 238 are used. Therefore, the probe is trained based on hidden states 240 produced for a grounded token and hidden states 242 produced for a hallucination token. The inputs 244 to training system architecture 230 include a history 246, knowledge source 248, and instruction 250, which, as described above, may be part of a prompt to transformer 102.

The inputs 244 also include annotated training tokens 252 (or annotated training data). Annotated training data 252 can be generated in a plurality of different ways. For instance, annotated training tokens 252 can be annotated at a response-level annotation where the entire response is labeled as containing a hallucination, or not. In another example, the annotated training tokens 252 are annotated at the token level to indicate whether individual tokens (or span of tokens) contain hallucinations. In the case of response-level annotation, in order to fit the probe parameters, Q, the negative log likelihood of the probe output on the response0level labels is minimized according to:

$$ℒ ( θ ) ∝ {\sum }_{( x , y ) ∈ 𝒟} - log p ( y \vert x ; θ ) \qquad EQ . 7$$

When token-level annotation is used, the parameters are fit by minimizing the negative log-likelihood over probes at each sequence position as follows:

$$ℒ ( θ ) ∝ {\sum }_{( x , y ∈ 𝒟 )} {\sum }_{i = 1}^{\vert x \vert} - log p ( {y}_{i} \vert {x}_{i} ; θ ) \qquad EQ . 8$$

Probe training system 260 has access to the hidden states 240 and 242 for both the grounded tokens and the hallucination tokens and trains probe 138 to recognize that a hallucination is being generated based upon those hidden states. For single-layer probes, it has been found that the most salient layers are in the middle layers of the transformer 120, during decoding. Probe performance shows a consistent and gradual increase from the first layer in the transformer 102 up until layers 10-20, after which there is a consistent decline in hallucination classification performance for higher layers. Some performance variation occurs during different generation tasks. Further, training the ensemble probe 180 (FIG. 6) on only the hidden states of the same type at every layer of the multi-layer perceptron has improved performance in model grounding behavior.

FIG. 9 is a flow diagram illustrating one example of the operation of training system architecture 230. An annotator (e.g., human or automated) identifies whether a response (e.g., an organic response generated during user interaction or a synthetic response generated by an annotator or otherwise) is a hallucination relative to a given knowledge source. Identifying whether the response is a hallucination is indicated by block 280 in the flow diagram of FIG. 9. In one example, a hallucination is identified if the response contradicts the knowledge source 248, as indicated by block 282. In another example, the response is identified as a hallucination if the response draws a conclusion that is not explicit in the knowledge source 248, as indicated by block 284. Other criteria can be used to indicate whether the response is a hallucination, as indicated by block 286.

Then, for any generated response that has been identified as a hallucination, the span of tokens that are ungrounded (or that are hallucinations) is identified, and annotated, as such. Identifying and marking the span of tokens that are ungrounded is indicated by block 288 in the flow diagram of FIG. 9.

Probe training system 260 then detects the hidden states 240 for a grounded token and hidden states 242 for the hallucination token, as indicated by block 290 in the flow diagram of FIG. 9. The hidden states can be detected as a vector of state values, as indicated by block 292. The hidden states can be obtained from a self-attention layer 294 or from an MLP or a feed-forward layer 296, or from other layers 298 in the transformer 102. Probe training system 260 then trains a single layer linear classifier, as indicated by block 300 and aggregates hidden state values to train an attention-pooling probe 302. Similarly, probe training system 260 combines multiple probe outputs to train an ensemble probe, as indicated by block 304. It will be noted that training system 260 need not train all of the different types of probes, but may train only the probes that have been identified as performing best, given the application and configuration of the transformer 102.

In one example, during training, the llama-2-13b model is used as the base model to generate responses to tasks in each domain. To ensure a non-negligible volume of both hallucinations and grounded responses were present in the generations for each task, model responses to all tasks were generated using k=2 Top-K random sampling with variations in the number of few-shot in-context learning examples given for each task.

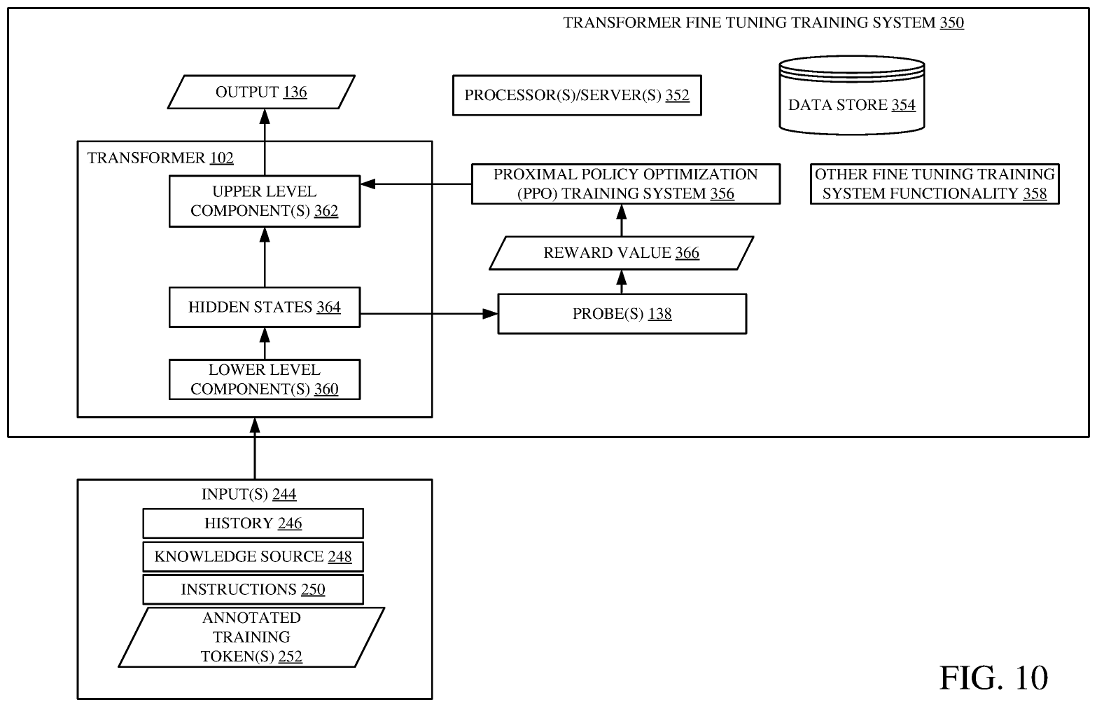

FIG. 10 is a block diagram showing one example of transformer fine tuning training system 350. Training system 350 can include a number of processors or servers 352, data store 354, proximal policy optimization (PPO) training system 356, a probe (such as linear classifier 138) and any of a wide variety of other fine tuning training system functionality 358. In the example shown in FIG. 10 training system 350 is receiving input 244 (described above) to train a transformer 102.

FIG. 10 shows a simplified block diagram for transformer 102 which includes a set of lower level components (encoders, decoders, etc.) 360, and a set of upper level components (encoders, decoders, etc.) 362. One or more probes 138 is deployed to detect the hidden or internal states 364 generated by the different components, layers, etc. within the lower level components 360 and to generate an output (identified as a reward value) 366 that is input into PPO training system 356. Thus, probes 138 generate an output indicative of how likely the hidden state 364 predict that the token being generated during fine tuning is a hallucination. The output may be a reward value (or a negative reward value) 366 that is provided to PPO training system 356. Based upon the reward value 366, PPO training system 356 trains the model parameters in the upper level components 362 of transformer 102. In one example, the parameters of the lower level components 360 are frozen during fine tuning so that only the parameters of the upper level components 362 are fine tuned.

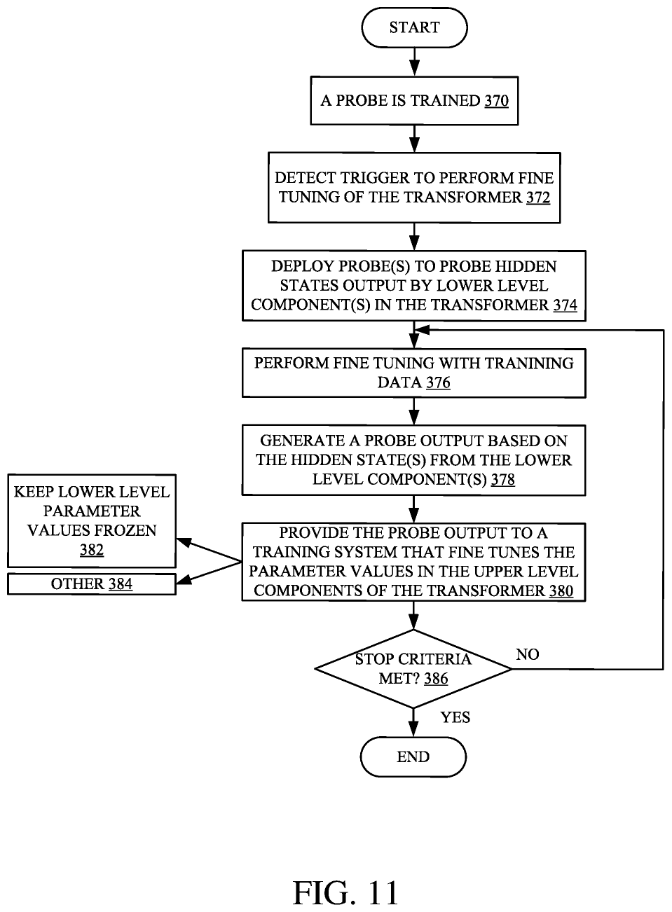

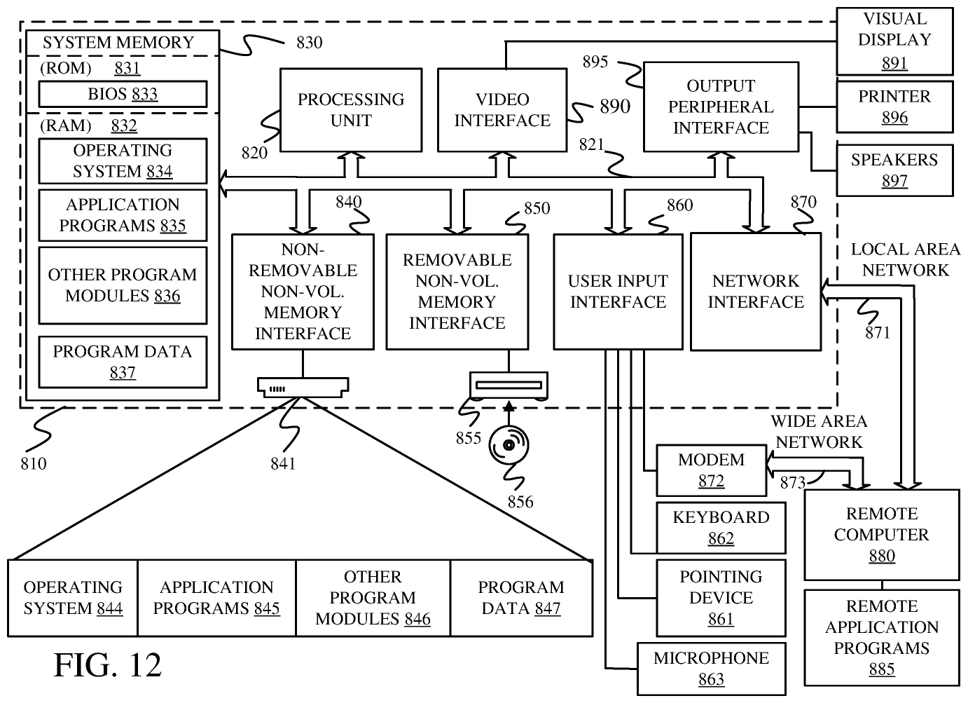

FIG. 11 is a flow diagram illustrating one example of the operation of the training system 350 shown in FIG. 10. It is first assumed that a probe 138 has been trained to generate an output indicative of how likely a current token being generated will be a hallucination, based upon the hidden states of one or more levels in a transformer 102. Having a trained probe 138 is indicated by block 370 in the flow diagram of FIG. 11. At some point, fine tuning training system 350 is triggered to begin fine tuning the model parameters in transformer 102. Detecting such a trigger is indicated by block 372 in the flow diagram of FIG. 11.

If it has not already been deployed, then one or more probes 138 are deployed to probe hidden states 364 of lower level components 360 in transformer 102. Deploying probe 138 is indicated by block 374 in the flow diagram of FIG. 11.

Tuning training system 350 then receives training data inputs 244 to begin the fine tuning process, as indicated by block 376 in the flow diagram of FIG. 11. During fine tuning, one or more probes 138 receive hidden states 364 generated by one or more of the lower level components 360 and generate, as an output, reward value 366 which is indicative of how likely it is that the current token being generated is a hallucination. This reward value 366 is provided to PPO training system 356. Generating a probe output based on the hidden states 364 from the lower level components 360 is indicated by block 378 in the flow diagram of FIG. 11.

PPO training system 356 makes small adjustments to the parameters in the upper level components 362 based on the reward value 366, which may be processed as a type of negative reward value. In other words, if the likelihood that the current token is a hallucination, output by probe 138, is relatively high, then PPO training system 356 should modify the parameters in the upper level components 362 more aggressively to train the transformer 102 not to generate that token in output 136. Providing the probe output to PPO training system 356, that fine tunes the parameter values in the upper level components 362 of the transformer 102, is indicated by block 380 in the flow diagram of FIG. 11.

Also, in one example, the parameter values in the lower level components 360 are frozen during this fine tuning process. If the lower level components 360 were also allowed to change, this would eventually train transformer 102 to evade hallucination detection by probes 138, but not necessarily to avoid generating hallucinations. Thus, the parameters of the lower level components 360, which are used by probe 138 to generate the reward value 366, are frozen during fine tuning, as indicated by block 382 in the flow diagram of FIG. 11. The probe output can be provided to PPO training system 356 in other ways as well, as indicated by block 384.

This training continues until fine tuning training system 350 detects stop criteria which can be any of a wide variety of different types of stop criteria. In one example, the stop criteria may include metrics indicative of the performance of transformer 102 of transformer 102. If the performance stops improving or improves by less than a threshold amount, this may be detected as one of the stop criteria. Any of a wide variety of other stop criteria can be used as well. Determining whether the stop criteria are met is indicated by block 386 in the flow diagram of FIG. 11.

The present description thus describes a system in which the hidden states (which are already generated by a large language model) can be used to identify hallucinations or other undesirable generations so that another large language model need not be run on the surfaced response to identify hallucinations. This greatly reduces the processing overhead needed to perform faithfulness analysis (or hallucination identification) over other current systems which use the secondary models to identify unfaithful or hallucinating responses. By way of example, assuming a given number (1000) of grounding tokens and also a given number (100) of generated tokens, then a lower bound on the number of floating point operations (FLOPS) for the secondary model would be 14.3 trillion FLOPS. By contrast, for the linear classifier probe described herein, the number of FLOPs is 409, 600 FLOPs. For the attention pooling probe, the number of FLOPs is approximately 41.4 million FLOPs, and for the ensemble probe, the number of FLOPs is 2.65 billion FLOPs. Thus, even the most complex probe described herein (the ensemble probe) performs over 14 trillion fewer operations than a secondary LLM, yet exhibits superior performance. This means that the linear probe and the attention pooling probe described herein consume far less than 0.01% of the compute resources used by the secondary model, and the ensemble probe uses less than 0.02% of the compute resources used by the secondary model.

It has been found that the probes described herein can out-perform current methods in which secondary models are used to identify hallucinations or faithfulness to the underlying knowledge source. This result was similar regardless of whether the probe was detecting response-level hallucinations or token-level hallucinations.

It will be noted that the above discussion has described a variety of different systems, components, layers, encoders, decoders, generators, probes, and/or logic. It will be appreciated that such systems, components, layers, encoders, decoders, generators, probes, and/or logic can be comprised of hardware items (such as processors and associated memory, or other processing components, some of which are described below) that perform the functions associated with those systems, components, layers, encoders, decoders, generators, probes, and/or logic. In addition, the systems, components, layers, encoders, decoders, generators, probes, and/or logic can be comprised of software that is loaded into a memory and is subsequently executed by a processor or server, or other computing component, as described below. The systems, components, layers, encoders, decoders, generators, probes, and/or logic can also be comprised of different combinations of hardware, software, firmware, etc., some examples of which are described below. These are only some examples of different structures that can be used to form the systems, components, layers, encoders, decoders, generators, probes, and/or logic described above. Other structures can be used as well.

The present discussion has mentioned processors and servers. In one example, the processors and servers include computer processors (graphics processing units, central processing units, etc.) with associated memory and timing circuitry, not separately shown. The processors and servers are functional parts of the systems or devices to which the processors and servers belong and are activated by, and facilitate the functionality of the other components or items in those systems.

A number of data stores have also been discussed. It will be noted the data stores can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

FIG. 10 is one example of a computing environment in which architecture 100, or parts of it, (for example) can be deployed. With reference to FIG. 10, an example system for implementing some embodiments includes a computing device in the form of a computer 810 programmed to operate as described above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 10 illustrates operating system 834, application programs 835, other program modules 836, and program data 837.

The computer 810 may also include other removable/non-removable volatile/nonvolatile computer storage media. By way of example only, FIG. 10 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 10, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 10 illustrates remote application programs 885 as residing on remote computer 880. It will be appreciated that the network connections shown are examples and other means of establishing a communications link between the computers may be used.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
a generative artificial intelligence (AI) transformer configured to receive an input and perform a generative operation to generate a set of output tokens, over a plurality of time steps, based on the input, the generative AI transformer including a decoder stack of a plurality of decoders, a first decoder, of the plurality of decoders, having a plurality of processing layers, a first processing layer of the plurality of processing layers receiving an input and generating a hidden state output;
a probe configured to detect the hidden state output and generate a probe output, based on the detected hidden state output, indicative of whether a token being generated by the AI transformer is an undesirable token; and
an action generator configured to generate an action signal based on the probe Output.

2. The computing system of claim 1 wherein the probe comprises:
a linear classifier configured to detect, as the hidden state output, a hidden state output from a single processing layer and generate the probe output based on the hidden state output from the single processing layer.

3. The computing system of claim 1 wherein the probe comprises:
a pooling probe configured to aggregate hidden state outputs over a plurality of time steps and generate the probe output based on the aggregated hidden state outputs.

4. The computing system of claim 3 wherein the pooling probe comprises:
a prior hidden state pooling system configured to store hidden state outputs generated during prior time steps in the generative operation; and
an aggregation system configured to aggregate the hidden state outputs generated during prior time steps in the generative operation to generate the probe output.

5. The computing system of claim 1 wherein the probe comprises:
a set of probes, each probe in the set of probes being configured to detect a hidden state output from a different processing layer, of the plurality of processing layers, and generate a corresponding probe output; and
an ensemble probe configured to receive the probe outputs corresponding to the probes in the set of probes and generate, as the probe output, a final probe output based on the probe outputs corresponding to the probes in the set of probes.

6. The computing system of claim 5 wherein the set of probes comprises:
a separate probe corresponding to each processing layer in the generative AI transformer and configured to detect a hidden state output from the corresponding processing layer in the AI transformer.

7. The computing system of claim 6 wherein each of the separate probes comprises:
a linear classifier configured to generate a linear classifier output indicative of how likely it is that the token being generated is an undesirable token.

8. The computing system of claim 1 wherein the plurality of processing layers comprises:
an attention layer; and
a feed-forward layer, wherein the probe is configured to detect the hidden state output from the attention layer and generate the probe output, based on the detected hidden state output from the attention layer.

9. The computing system of claim 1 wherein the plurality of processing layers comprises:
an attention layer; and
a feed-forward layer, wherein the probe is configured to detect the hidden state output from the feed-forward layer and generate the probe output, based on the detected hidden state output from the feed-forward layer.

10. A computer implemented method, comprising:
receiving a prompt at a generative artificial intelligence (AI) transformer;
performing a generative operation to generate a set of output tokens, over a plurality of time steps, based on the prompt;
detecting an internal state of the generative AI transformer during the generative operation; and
generating a probe output, based on the detected internal state, indicative of whether a token being generated by the AI transformer is an inconsistent token that is inconsistent with information in the prompt.

11. The computer implemented method of claim 10 and further comprising:
generating an action signal based on the probe output.

12. The computer implemented method of claim 10 wherein the generative AI transformer includes a decoder stack of a plurality of decoders, a decoder, of the plurality of decoders, having a plurality of processing layers, and wherein detecting an internal state comprises:
detecting, as the internal state, an internal state output from a single processing layer and wherein generating the probe output comprises generating the probe output based on the internal state output from the single processing layer.

13. The computer implemented method of claim 12 wherein generating the probe output comprises:
running a linear classifier on the detected internal state to generate a linear classifier output indicative of how likely it is that the token being generated is an undesirable token.

14. The computer implemented method of claim 10 wherein detecting an internal state comprises:
aggregating internal states output over a plurality of time steps and wherein generating the probe output comprises generating the probe output based on the aggregated internal states.

15. The computer implemented method of claim 10 wherein detecting an internal state comprises:
detecting a first internal state output from a first processing layer in the generative AI transformer;
generating a first probe output based on the first internal state;
detecting a second internal state output from a second processing layer in the generative AI transformer;
generating a second probe output based on the second internal state; and
generating, as the probe output, a final probe output based on the first probe output and the second probe output.

16. The computer implemented method of claim 10 wherein the generative AI transformer includes a decoder stack of a plurality of decoders, a decoder, of the plurality of decoders, having a plurality of processing layers comprising an attention layer and a feed-forward layer, wherein detecting the internal state comprises:
detecting the internal state output from the attention layer and wherein generating the probe output comprises generating the probe output based on the detected internal state output from the attention layer.

17. The computer implemented method of claim 10 wherein the generative AI transformer includes a decoder stack of a plurality of decoders, a decoder, of the plurality of decoders, having a plurality of processing layers comprising an attention layer and a feed-forward layer, wherein detecting the internal state comprises:
detecting the internal state output from the feed-forward layer and wherein generating the probe output comprises generating the probe output based on the detected internal state output from the feed-forward layer.

18. A computer implemented method, comprising:
performing a generative process with a large language model; and
detecting whether a hallucination is being generated during the generative process based on an internal state of the large language model.

19. The computer implemented method of claim 18 wherein performing a generative process comprises generating tokens over a plurality of time steps and wherein detecting whether a hallucination is being generated comprises:
detecting whether a hallucination is being generated based on the internal state of the large language model over a plurality of different time steps.

20. The computer implemented method of claim 19 wherein the large language model includes a plurality of different processing layers and wherein detecting whether a hallucination is being generated comprises:
detecting whether a hallucination is being generated based on the internal states output from the plurality of different processing layers in the large language model.
